(19) United States
(12) Patent Application Publication
(10) Pub. No.: US 2002/0180803 A1
(43) Pub. Date: Dec. 5, 2002

(54) Systems, methods and computer program products for managing multimedia content

(75) Inventors: Jon Kaplan, Naples, FL (US); Robert Protheroe, Naples, FL (US); Randy Martin, Naples, FL (US); David Riggle, Naples, FL (US); Juan Gonzales, Naples, FL (US)

Correspondence Address: HAHN LOESER & PARKS, LLP, TWIN OAKS ESTATE, 1225 W. MARKET STREET, AKRON, OH, 44313, US

(73) Assignee: SmartDisk Corporation

(21) Appl. No.: 09/821,437

(22) Filed: Mar. 29, 2001

(51) Int. Cl. G06F 3/14

(52) U.S. Cl. 345/810

(57) ABSTRACT

The present invention is a multimedia management system for storing, manipulating, displaying, and packaging multimedia content. The invention includes different aspects of handling and display of multimedia content, both on a PC and in association with external storage media. The system provides a visual inventory of such files to facilitate retrieval of desired content from external removable media such as CD's, DVD's or removable disk drives. Additionally, the present invention is directed to systems and methods for creating, organizing, distributing, and packaging digital content in a convenient manner.

### TECHNICAL FIELD

The present invention relates generally to multimedia content systems, and more particularly to systems, methods and computer products for managing multimedia content. Specifically, the present invention relates to software/hardware systems that are used to create, organize, and master multimedia content. The present invention also includes the capability to disseminate multimedia content over a computer network such as the Internet.

### BACKGROUND OF THE INVENTION

The popularity of multimedia content is rapidly expanding for use on personal computers (PCs), handheld devices and across the Internet. Today, the ability to stream or download multimedia content, such as movies and music, to a PC from the Internet is increasing daily. The number and types of computer program data files are also increasing. Currently, there are computer program file formats for digital video, digital audio and text, still images, 3D animation, and MIDI (Musical Instrument Digital Interface). Several examples of such data files include JPEG (Joint Photographic Experts Group), GIF (Graphic Interchange Format), TIFF (Tag Image File Format), MOV, WAV, AVI (Audio Visual Interleaved), and MP3 (Moving Picture Exports Group 1, Audio Layer 3). Other data file formats are being developed regularly. On the Internet today, PC users can access multimedia versions of television and cable network programs. Users can also stream or download movie or music trailers for popular movies and music videos. Due to advancements in PCs and the development of digital devices such as DVD, digital cameras, digital video recorders and related technology, users are also generating their own multimedia content, web sites, digital movies and other digital multimedia at an astounding rate. Musicians use PCs to create digital music using MIDI. Writers and directors are filming and editing their own feature films on PCs using a variety of digital movie formats. Everyone from large corporations to individuals is creating their own web sites that incorporate any number of multimedia formats. As a result, it is becoming increasingly difficult for even the most technical individuals to keep track of and organize their computer files containing multimedia content. Furthermore, once the multimedia content is organized, many users wish to distribute copies of their multimedia content to others, such as family members, friends, or associates so they can view the multimedia content as well.

### SUMMARY OF THE INVENTION

The present invention is directed to systems, methods and computer products for managing multimedia content in a manner that the content can be organized in a way to facilitate creating removable media with desired multimedia content in a hierarchical structure for playback and creation of user customized removable media labels, cover materials, insert materials, and packaging materials. The invention in one aspect provides one button authoring and burning or creation of removable media and all associated content, with the hierarchical structure of the content translated to the structure of the content on the removable media. This in turn allows playback of the removable media on a suitable playback or embedded device, while providing playback options based upon the hierarchical structure of the content on the media. The invention thus provides simplified systems, methods and computer programs for storing, manipulating, displaying, and packaging multimedia content.

In one aspect, the invention is directed to systems and methods for organization of digital multimedia content, based upon subject matter or other characteristics of the multimedia. The organized digital multimedia content is encoded into a predetermined digital format for storage on a removable media, such as a compact disc (CD), in the predetermined digital format. The system and method allows one button authoring and burning of the CD, and provides for selective playback options on any suitable playback device. Using the system, the user creates a stream of encoded digital data comprising the selected digital multimedia content as organized. The system and method provide authoring and burning of the CD or generating of removable media with the desired multimedia content by a single user implemented operation. The CD or other removable storage media generated in this manner may then be used for playback of the multimedia content on any other PC or within any playback device, such as a DVD player, supporting the digital format in which the information is encoded. The ability to simply organize, and simply author digital multimedia content in this manner provides significant advantages in the handling of such multimedia content, and facilitates distribution and use of such content.

Various systems, methods and products of the present invention may utilize multimedia content from any source, such as content captured and managed according to the management system as described in co-pending U.S. Provisional Applications, Serial No. 60/200,096 filed Apr. 27, 2000 and No. 60/202,469 filed May 8, 2000, which are hereby incorporated by reference. The management system provides a visual inventory of all multimedia content, whether on the PC or stored on external removable media, to facilitate retrieval of desired content from external removable media such as CD's, DVD's or removable disk drives. Content is indexed by the system for easy retrieval from such removable media or from the PC database by reference to a relevant index file to minimize the searching necessary to locate specific content. As an example, with the burgeoning use of digital cameras and digital video recorders, individuals are creating a voluminous amount of digital files stored on CD's or other external storage media, and any specific photograph or movie clip must be searched for throughout the user's collection of removable media. When the present invention is used in conjunction with the multimedia management system that is described in the aforementioned provisional patent applications, a completely seamless and integrated multimedia handling system is established. Specifically, the multimedia management system user interface provides a plurality of predefined functions to uniquely index multimedia files, create an index database file, and create visual representations of the files for later retrieval via a media library function of the media management system resident on a PC. The indexed file stores a pointer in the management system database to the physical file location, while providing a thumbnail image that can be used to represent the file in the management system user interface. This allows multiple pointers in the media management database, which relate to a single physical file stored on computer media. Thus, there is no need to storage of multiple physical files of the multimedia data, thereby saving storage space. Additionally, the media management system allows organization of the multimedia files into virtual albums of favorite multimedia files for easy access, while archiving the source material. The indexing system will automatically drop the indexing information into the library files for access. In this manner, the multimedia management system allows the digital multimedia content to be organized in a manner which allows the user to author a CD wherein such content is output on the external media in a desired format by simply clicking one button. The multimedia content may be formatted in a manner that upon playback, whether in a DVD player, another digital media player or a PC, provides menu information for accessing the multimedia content.

The invention is also directed to providing the media management system in conjunction with an embedded device, for playback of multimedia content generated on removable media as described. The media management system engine can be provided in an embedded or dedicated playback device, such that the removable media is simply inserted into the device and will automatically play back on the device, without requiring any operation or functions to be performed by the user.

The systems, methods and products of the present invention also provide user interface utility programs to allow a user to create CD's, DVD's or the like using the digital content of interest. Full CD/DVD/Mini Disc (MD) mastering capabilities, including the creation of a user customized CD/DVD/MD label, cover materials, insert materials, jewel case and content are one feature of the present invention. The mastering utilities of the present invention allow the user to create graphic and other informational content for use with labeling the removable media. Furthermore, the labeling capabilities of the present invention are also applicable for use in association with the removable media's storage case or housing, and is printable on appropriate labels or materials.

The mastering utility also has the capability of allowing a user to select desired digital content and to create a custom CD or other removable media. A portable playback utility program can be integrated with the multimedia content that is mastered onto the CD/DVD or other removable media. Thus, when the creator of a customized CD/DVD masters the multimedia content, a multimedia viewing utility may be supplied along with the multimedia content. This software viewer is self-contained with the multimedia content, and allows the mastered CD/DVD to be played back on any PC. Software could also be provided to allow the user to manipulate the content easily. In this way, custom slideshows or other multimedia presentations may be created and easily played by a user.

In another aspect, the present invention provides the ability to organize multimedia content stored on flash media readers, with flash memory being used by many digital devices for temporary storage of multimedia content. A removable media reader, such as a flash media reader, may be configured with firmware to support the multimedia management system, or the operating system can be used to notify the multimedia management system that new removable media has been inserted, regardless of the type of removable media. The detection of the flash memory or removable media would automatically launch a software wizard to prompt the user on organizing and storing the multimedia content. Alternatively, multimedia content may be pre-configured on external storage media of a suitable type, such as write once memory devices such as contemplated to be produced by DataPlay, Inc., ROM devices, SmartMedia as produced Toshiba Corporation, or other flash memory devices. The preconfigured content will be stored on the media in a manner that when it is plugged into a reader or a PC, software resident on the PC will recognize the data format and pull the data into the multimedia management system for organization and storage and/or playback. Without the user having to perform any function, the multimedia content will be automatically organized within the multimedia management system based upon instructions provided in association with the multimedia content.

The present invention also relates to systems and methods for sharing the multimedia content in a simple manner with others such as friends or family members. The user organizes their multimedia content and is then able to select specific multimedia content to be accessed by specified individuals via the Internet. The user's PC will function as a server used for sharing content via standard Internet protocols, for example using TCP/IP and transferring contents of the shared materials using FTP. Appropriate multimedia viewing programs may be downloaded by a recipient to allow viewing of the multimedia content or an appropriate viewer may be resident on the recipient's PC. If the recipient has the media management system as described in the above provisional applications, the content could also be integrated into the recipients system for later access, or could be placed into a local database created on the recipient's PC. Alternatively, the content may be downloaded to an external device, such as a CD, and played back using a portable device provided with the software for accessing and playing the content. As a further example, the system and methods may also allow automatic adjustment of the resolution of the content for playback based upon the characteristics of the users particular playback system.

These along with other objects and advantages of the present invention will become more readily apparent from a reading of the detailed description taken in conjunction with the drawings and the claims.

### BRIEF DESCRIPTION OF THE DRAWINGS

FIG. 1 is a block diagrammatic depiction of various non-digital media as produced by various methods, which can be digitized and made available for use in the present invention.

FIG. 1A is a block diagrammatic depiction of digital media, which can be used in the present invention.

FIG. 2 is a block diagrammatic depiction of the functional components of a multimedia management system.

FIG. 3 is a block diagrammatic depiction of the functional components of the multimedia utility suite according to an embodiment of the invention.

FIG. 4 is a block diagrammatic depiction of the system and methods according to an embodiment of the invention.

FIG. 5 is a graphical representation of the user interface associated with the multimedia management system for implementing the systems and methods of the invention.

FIG. 6 is a block diagrammatic depiction of the authoring utility according to an embodiment of the invention.

FIG. 6A is a block diagrammatic depiction of an alternate embodiment of the authoring utility according to the invention.

FIG. 7 is a graphical representation showing the organization and selection of multimedia content via the user interface.

FIG. 7A is a graphical representation showing the mapping of multimedia content to removable media based upon the organization and selection of multimedia content via the multimedia management system.

FIG. 8 is a block diagrammatic depiction of the operation of the CD/DVD mastering utility of the present invention.

FIG. 9 shows front and back elevational views of a finished CD label, cover, and insert created using the removable media mastering utility of the present invention.

FIG. 10 is a block diagrammatic depiction of the operation for the media sharing utility of the present invention.

FIG. 11 is a block diagrammatic depiction of the operation of the media wizard utility of the present invention.

### DETAILED DESCRIPTION OF THE INVENTION AND DRAWINGS

The present invention is fully described hereinafter with reference to the attached pages, in which preferred embodiments of the invention are shown. The invention may also be embodied in many different forms and should not be construed as limited to only the disclosed embodiments. The provided embodiments are included so the disclosure will be thorough, complete and will fully convey the scope of the invention to persons of ordinary skill in the art.

A person of ordinary skill in the art would appreciate that the present invention may be embodied as a method, data processing system, computer program product or may include devices for management and access to digital content developed by the user. As such, the present invention may take the form of an embodiment comprised entirely of hardware; an embodiment comprised entirely of software or an embodiment combining software and hardware aspects. In addition, the present invention may take the form of a computer program product on a computer-readable storage medium having computer-readable program code means embodied in the medium. Any suitable computer readable medium may be utilized including hard disks, flash memory cards, CD-ROMs, optical storage devices, or magnetic storage devices.

The present invention may be described with reference to flowcharts and/or diagrams that illustrate methods, apparatus or systems and computer program products. It should be understood that each block of the various flowcharts, and combinations of blocks in the flowcharts, can be implemented by computer program instructions. Such computer program instructions can be loaded onto a general-purpose computer, special purpose computer, or other programmable data processing device to produce a machine, such that the instructions that execute on the computer or other programmable data processing apparatus create means for implementing the functions specified in the flowcharts. The computer program instructions can also be stored in a computer-readable memory that directs a computer or other programmable data processing device to function in a particular manner, such that the instructions stored in the computer-readable memory produce an article of manufacture including instruction means which implement the function specified in the flowcharts or diagrams. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowcharts or diagrams.

It will be understood that blocks of the flowcharts or other descriptive indicia support combinations of means for performing the specified functions, combinations of steps for performing the specified functions and program instruction means for performing the specified functions. It is also to be understood that each block of the flowcharts or diagrams, and combinations of blocks in the flowcharts or diagrams, can be implemented by special purpose hardware-based computer systems which perform the specified functions or steps, or combinations of special purpose hardware and computer instructions.

The present invention could be written in a number of computer languages including, but not limited to, C, C++, Basic, Visual Basic, Smalltalk, Java, and other conventional programming languages. It is to be understood that various computers and/or processors may be used to carry out the present invention without being limited to those described herein. The present invention can be implemented on an IBM or IBM-compatible personal computer, preferably utilizing a DOS, Windows 3.1, Windows 95, Windows 98, Windows NT, Unix, Linux or OS/2 operating system. The present invention could also be implemented on an Apple or Apple-compatible personal computer, preferably utilizing its own operating system. However, it should be understood that the present invention could be implemented using other computers and/or processors, including, but not limited to, mainframe computers, mini-computers, personal digital assistant (PDA) devices, embedded or dedicated devices for playback of multimedia content or other suitable devices.

More specifically, the present invention provides users with a simple and intuitive method and computer program for reviewing and managing their multimedia content, which can include digital video, digital audio and text, still images, animation, and MIDI. The various types of multimedia content are typically in the form of digital computer file formats. Today there are dozens of multimedia file formats such as JPEG, GIF, TIFF, MOV, WAV, AVI, and MP3. The present invention also provides the unique ability to create removable media containing digital content so that the content can be shared or played back via a standard player device or another PC. The invention also provides the ability to share content via the Internet for simple access and viewing by a recipient.

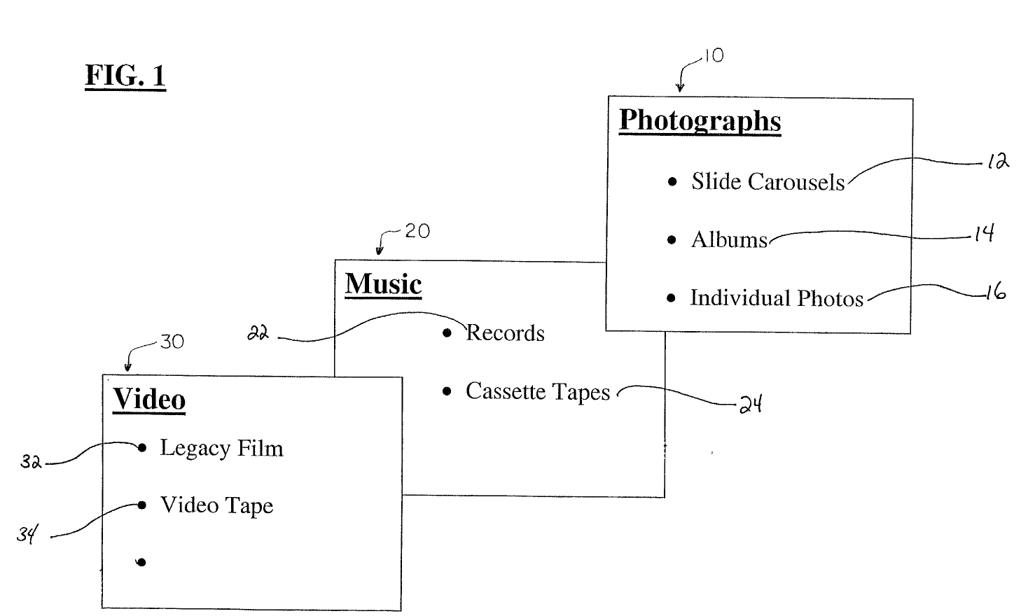

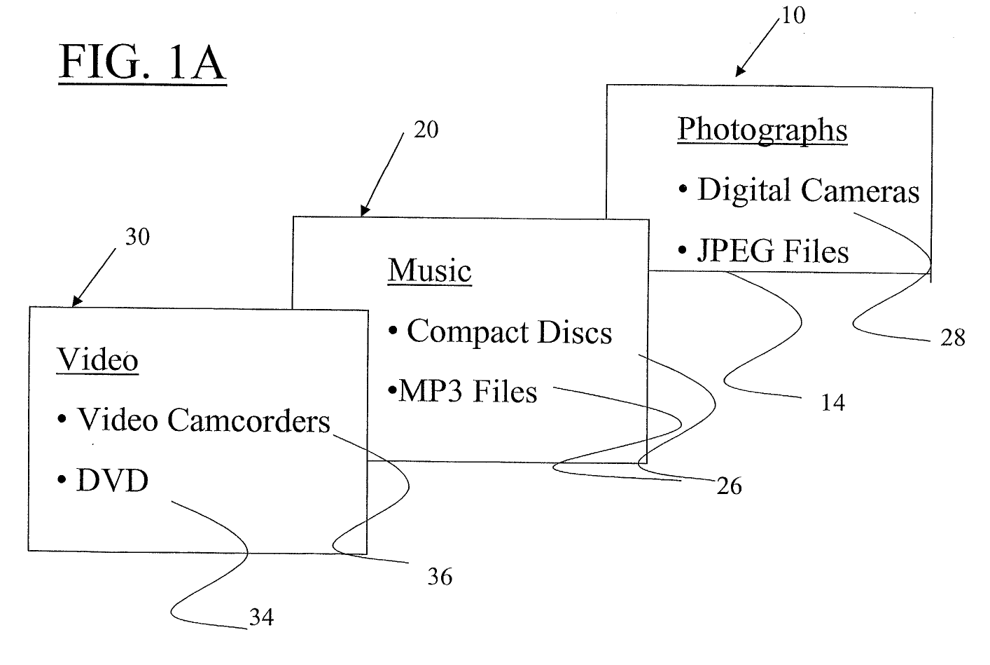

Turning now to FIG. 1, non-digital or what may be referred to as legacy media content has in the past come in a variety of analog forms including photographs as generally indicated at 10, which in turn can come in a variety of forms such as slides housed in a slide carousel 12 photo albums 14, or miscellaneous discrete individual photographs as indicated at 16. Individual photographs which are not contained on slides or within a photo album typically are stored in bulk together in a box or other container. Other past legacy media content includes music 20, such as records 22, cassettes or other tapes 24 or other analog music formats. Additional forms of legacy media content include analog video or movie content 30, such as 8 millimeter or other film, video tape 34 for viewing on a video cassette recorder (VCR), or other video type materials or formats. It should be recognized that the variety of legacy media content stored on different media or forms presents significant problems for the user in terms of organization of their videos, music and pictures. Today, the user can convert legacy content of this type into digital format for organization and outputting in the multimedia management system. For example, a standard legacy photograph can be scanned into a PC using a flat bed scanner, such as the Hewlett Packard HP 4300 CSE.

As seen in FIG. 1A, with the advent of digital formats for each of these media types, the varieties of media have expanded greatly. Digital media as compared to the analog forms of FIG. 1 can be stored on a computer system. Even the analog media of FIG. 1 can be digitized to convert it to a proper form for storage and viewing on a computer system. Digital media include digital music formats, such as CD's 26, or other digital formats such as Mini Disc (MD), MP3, etc. Pictures are now taken with digital cameras 28, and stored in digital formats, and movies are taken with digital video cameras 36. Either original digital media, or analog or legacy media which has been transformed into a digital format, can then be stored on a personal computer (PC), as well as on external digital storage media such as a CD or DVD. The present invention is directed at providing the ability to handle and organize digital content, create removable media and distribute digital content in a simplified and effective manner, which enables the user to more easily access, share and enjoy multimedia content.

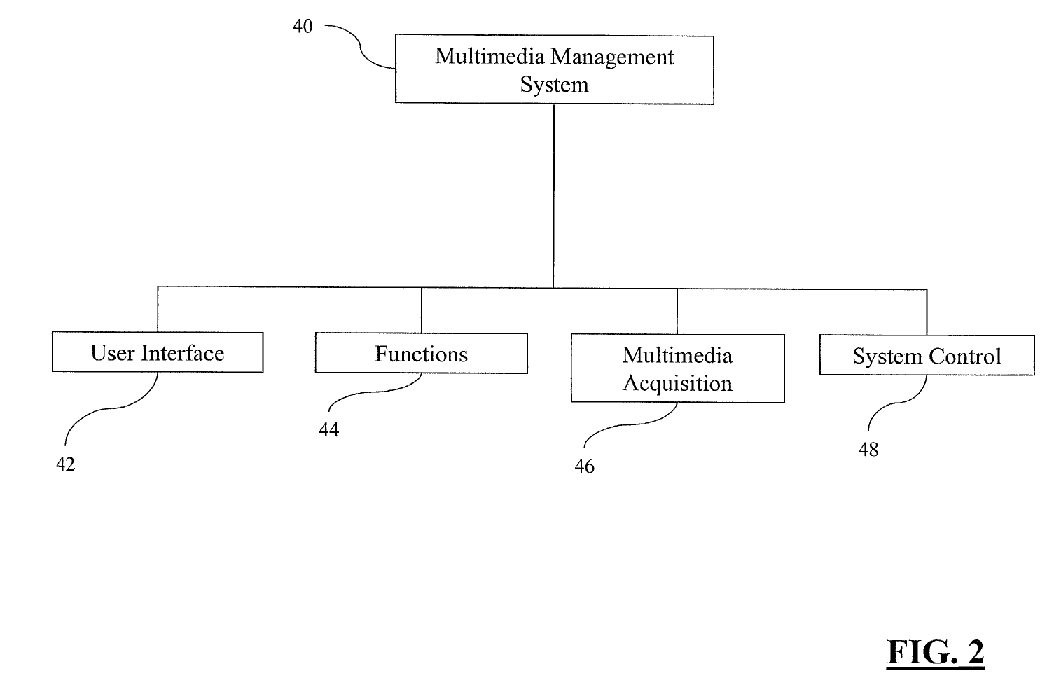

FIG. 2 refers to a block diagram of a multimedia management system 40 for storing, manipulating and displaying multimedia. The system 40 may comprise a user interface 42, a plurality of predefined functions 44, a multimedia acquisition interface 46, and system controls 48, as an example. The system 40 is designed to provide a user with a simple and easily implemented method, system and computer program for acquisition of multimedia content, management and storage thereof, as well as reviewing multimedia content on a PC. The multimedia content can include digital video, digital audio, still images, animation or other types of multimedia content now known or hereafter developed. Typically, various types of multimedia content may be stored in the form of a digital computer file, in a variety of multimedia file formats, such as JPEG, GIF, TIFF, MOV, WAV, AVI, MIDI and MP3. Other formats known or hereafter developed are also contemplated in the present invention. A suitable multimedia management system and methods may be in accordance with the invention as described in the applicant's co-pending provisional patent applications, which have been incorporated by reference. Other suitable multimedia management systems or tools may also be usable in conjunction with the present invention, and it should be understood that the present invention is not limited thereby. The management system is designed to organize the multimedia content into a hierarchical scheme in the preferred embodiment. Generally, the ability to transform all types of multimedia content into various digital formats which can be stored on a PC, allows the user to utilize the processing power of the PC to organize and easily retrieve the multimedia content. Alternatively, even without a multimedia management system, multimedia content may still be transformed into a digital format and stored on the PC, and subsequently used in accordance with the present invention.

The invention in one aspect is directed at providing the user a simple and effective way to create multimedia presentations from their sources of media as stored on their PC or acquired from the Internet or the like. The invention provides the user with the ability to create multimedia presentations using the hierarchical structure of the media as organized using the media management system 40. As will be described in further detail, the hierarchical organizational structure of the media can be used to provide selective playback options automatically in the created multimedia presentation, and can also be used to automatically master materials for removable media.

As will also be hereafter described in more detail, the invention allows the user to create multimedia presentations for playback on other PC's. Similar to creating removable media according to the invention, the user can organize and create a multimedia presentation and transfer it to others in electronic form for playback via the recipient's PC. For example, the multimedia presentation created according to the invention can be emailed to a recipient via the internet or other network, with the presentation including an executable file in an embedded player, such that upon receipt, the user may open the presentation and it will automatically play on their PC. Alternatively, the presentation could be created for playback via conventional media playback devices for use with PC's, such as Windows Media Player or the like.

The multimedia content, whether generated in digital form or legacy media converted to digital form can be stored on a PC or on removable media. The multimedia content can be archived on removable media to reduce PC memory requirements, and removable media can also be used to share multimedia content. The multimedia content is created or converted to a digital format which may be stored on a PC for archiving, storage and management thereof via the management system 40, as well as viewing or listening via the PC. It is also possible to store the digital multimedia content on external digital media storage formats such as CD's, DVD's or other digital removable media. Although in the recent past, the ability to create a CD or DVD has been limited to professional use for the most part, CD or DVD recording devices using recordable CD's (CDR or CDR/W) for use with their PC is increasing. Presently, a common use of the CDR/W is to create a digital audio CD, which can be played in any standard music CD player, thus allowing the user to download from the Internet music in digital formats which can then be recorded onto the CDR/W. Although not typical of today's use, the CDR/W drives presently can or will provide support for other digital formats, such as video CD 2.0 and super video CD formats, in addition to supporting standard audio CD formats. For example, video CD (VCD) 2.0 can support the storage of still pictures at various resolutions, such as the NTSC standard formats 352 by 240 or 704 by 480 presently. Additionally, video format, such as Mpeg-1, is supportable at resolutions of 352 by 240. This support is in addition to digital audio formats to provide stereo music. Likewise, super video CD (SVCD) also provides support for still pictures at resolutions of 480 by 480 or 704 by 480, as well as digital video such as Mpeg-2 at resolutions of 480 by 480. Additionally, digital audio is supported for stereo music or 5 plus 1 surround sound as examples.

In addition, most DVD players presently being sold support the VCD 2.0 or Super VCD standard, such that a CD created with digital multimedia content in the VCD 2.0 or Super VCD format can be played back on a DVD player. The present invention may also allow creation of a multimedia presentation in DVD format for playback on any DVD player. Such support on DVD players or CD players would also be expected to expand greatly to allow playing of a variety of digital formats therewith. There are also dedicated VCD 2.0 and SVCD format players as well as other dedicated format playback devices, and in addition to these present day capabilities, the significant expansion in the use of digital formats and provision of digital format players would be expected to continue. The present invention contemplates use of any such developments. The present invention also supports the creation of audio files, such as MP3 files, to create MP3 data CD's and Digital Audio CD's which can be played back on suitable playback devices.

Further to the above, digital formats many times will support use of multi-level menus, and presently VCD 2.0 and SVCD support the use of such multi-level menus. In this manner, multi-level menus can easily be implemented on a DVD or other digital format player to allow the user to use the menu for navigating through digital materials stored thereon a CD or DVD. In fact, present support of VCD 2.0 and SVCD formats on DVD players would allow the user to use their DVD remote control for navigating through menus to access digital multimedia content, such as pictures and videos, stored on their VCD 2.0 or SVCD organized CD. This would allow the user to browse, view and play content on their television or other monitor using the DVD remote control. Similarly, other digital content players will likely support such functions, and are contemplated for use in accordance with the invention. The present invention also allows for the development of dedicated portable media player that implements the functionality of the multimedia management system organization and preview program. The portable player would be approximately the size of PDA devices, such as the “Palm” and “CE” devices available today. The operating system could be any of the standard PDA OS's (e.g., Palm OS, CE OS, etc . . . ). When the device is turned on, a standard multimedia management system interface (e.g., Thumbnails) can be displayed on the PDA screen. The portable media may have pre-loaded content that can then be navigated and selected in the same basic method as described in the multimedia management system. The user may be able to play the thumbnails in place or play the content in full screen mode. Additional multimedia content (e.g., WAV, AVI, MP3, JPEG, etc . . . ) can be downloaded to the portable player through a removable flash socket (e.g., SmartMedia) or standard communication interfaces (e.g., USB, Firewire, RF, BlueTooth, etc . . . ). The portable player will allow a user to take their multimedia content anywhere with them and play it back for their enjoyment (e.g., plane, train, automobile, etc . . . ) using the same consistent multimedia navigation and organization system.

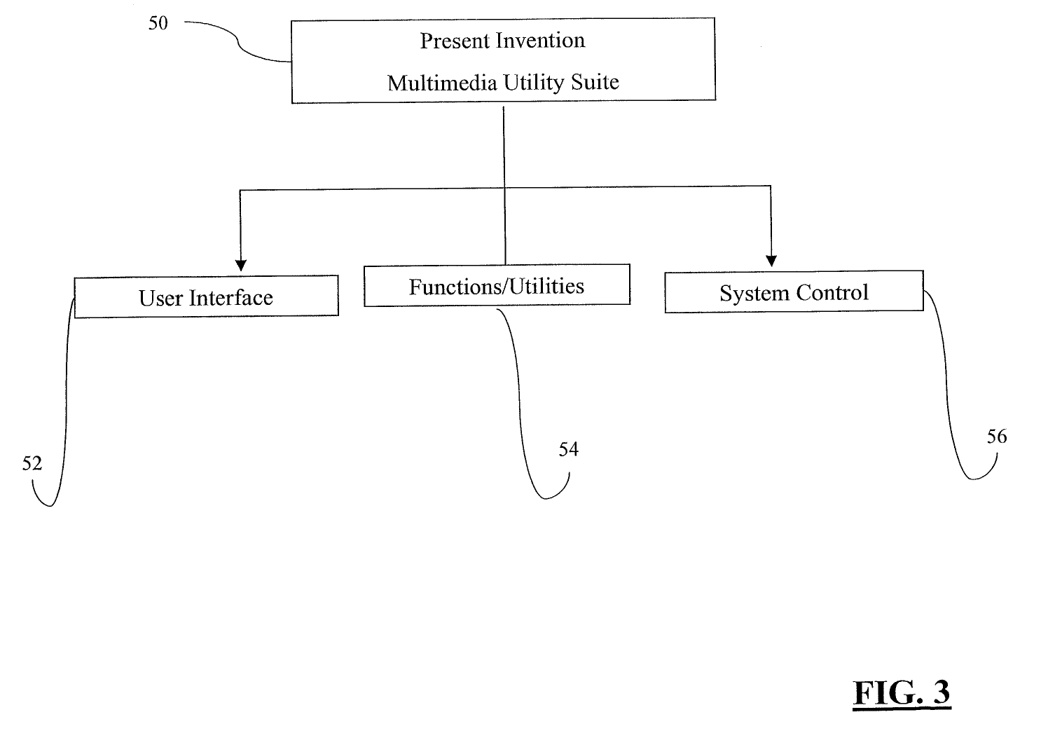

Turning to FIG. 3, the present invention 50 is comprised of a suite of integrated multimedia utility programs 54 that allow one to manipulate, organize, and create digital multimedia content. In one aspect the present invention is directed to an integrated system of computer hardware/software as well as methods. This computer hardware/software and method for the same provides the user with an easy to use interface 52 and system control 56 for organizing digital multimedia content, as well as for creating removable digital storage media, such as CD's, DVD's or other media, which can then be readily distributed and shared with family, friends or others.

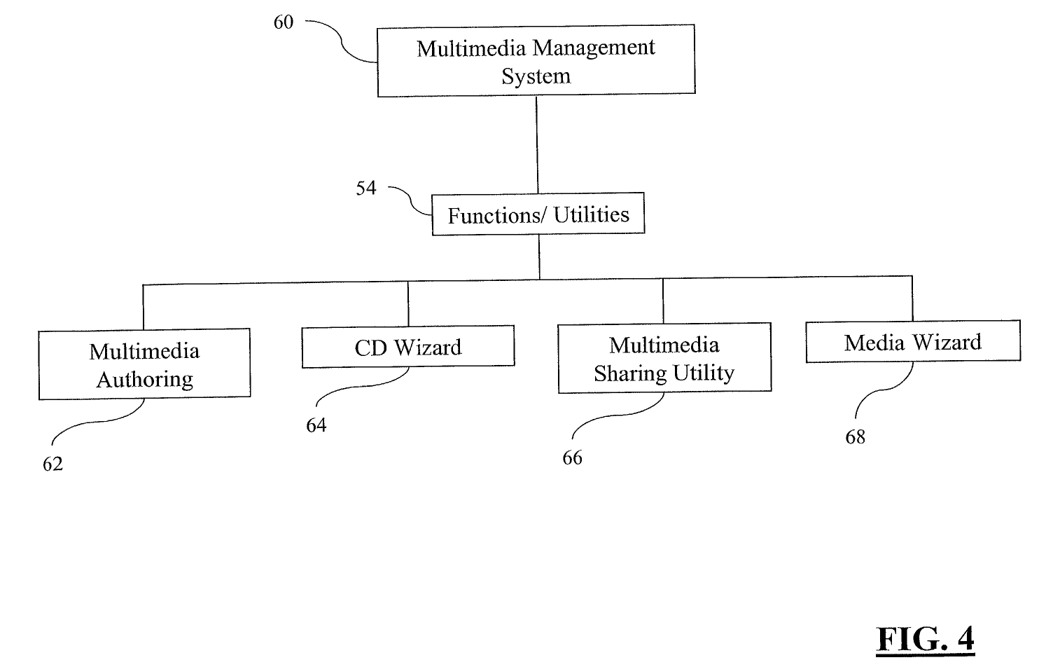

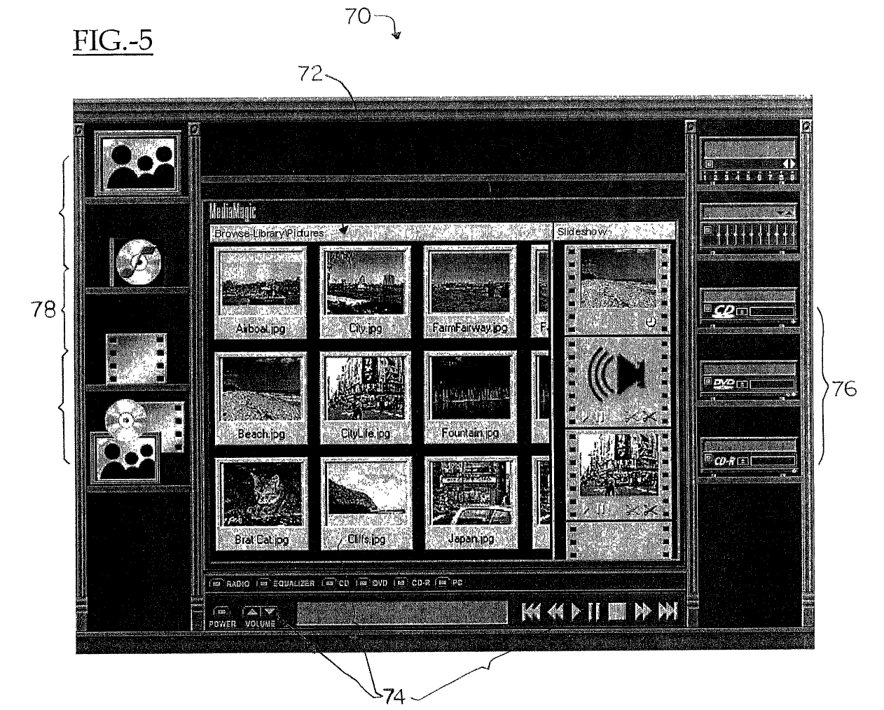

In FIG. 4, various functions and operations of the system and method according to the invention are shown generally. A multimedia management system 6 provides information to the functions/utilities 54. These functions/utilities include a multimedia authoring utility 62, allowing the user to create removable media having selected multimedia content thereon in a format suitable for playing on a digital media reader, with the organization of the multimedia content mapped to the removable media. There is also provided a CD wizard 64, which is used to create full CD mastering for a removable media. A multimedia sharing utility 66 is provided to allow a user to select multimedia content within the multimedia management system, which will be made accessible to another computer via an Internet connection. There is also provided a media wizard 68, which allows a media reader to support integration into the multimedia management system 60, in a manner to simply organize and store multimedia content in a selected manner. The multimedia management system 40 may include a user interface as shown in FIG. 5. In the embodiment shown, the user interface generally indicated at 70, may comprise an entertainment center appearance with media displayed on a “monitor or TV” representation 72. The “monitor” 72 may be configured to have several viewing areas, such as to browse through the Library of still pictures, watch a slideshow or the like. The interface 70 may also have control buttons 74, for controlling viewing options associated with the media and media presentations. There also may be representations of audio/video components 76, and representations of media types 78, which may be selected by the user.

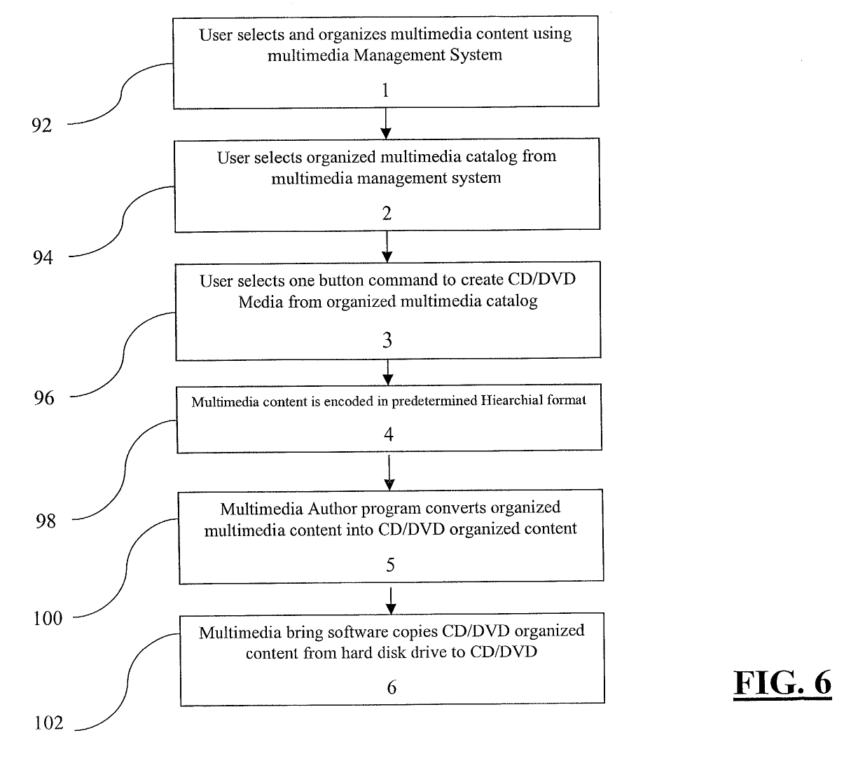

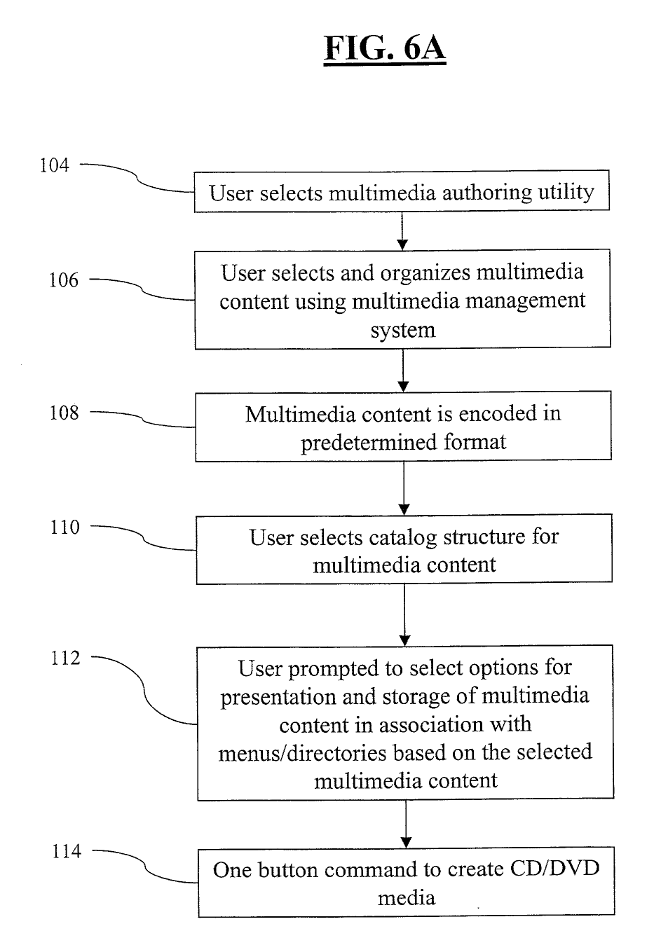

The authoring component of the system and methods is illustrated generally in FIG. 6. The multimedia management system allows creation of a multimedia presentation and automatically creates the presentation in a manner to prepare the user's archived multimedia files for outputting to removable media. The multimedia management system is initiated and the user is prompted to select the desired content that he or she wishes to transfer onto the removable, recordable media at 92. For example, using the multimedia management system with at least one main level and possibly further comprising at least one sub-level menu. This may be thought of in terms of creating a virtual library comprising “albums” having “sub-albums” and a pointer to the actual physical files stored on the computer or removable media. The user may then select the organized multimedia catalog from the multimedia management system at 94. The user could also select and structure actual files and directories into the hierarchical organization from the hard drive of the computer system, in addition to supporting the structure in the media management system database. Although nothing would limit the user from authoring removable media without a main menu (e.g., root directory) or sub-level menus, the organization of the content in the system allows the addition of such menus simply, and the menu allows easier navigation through the content.

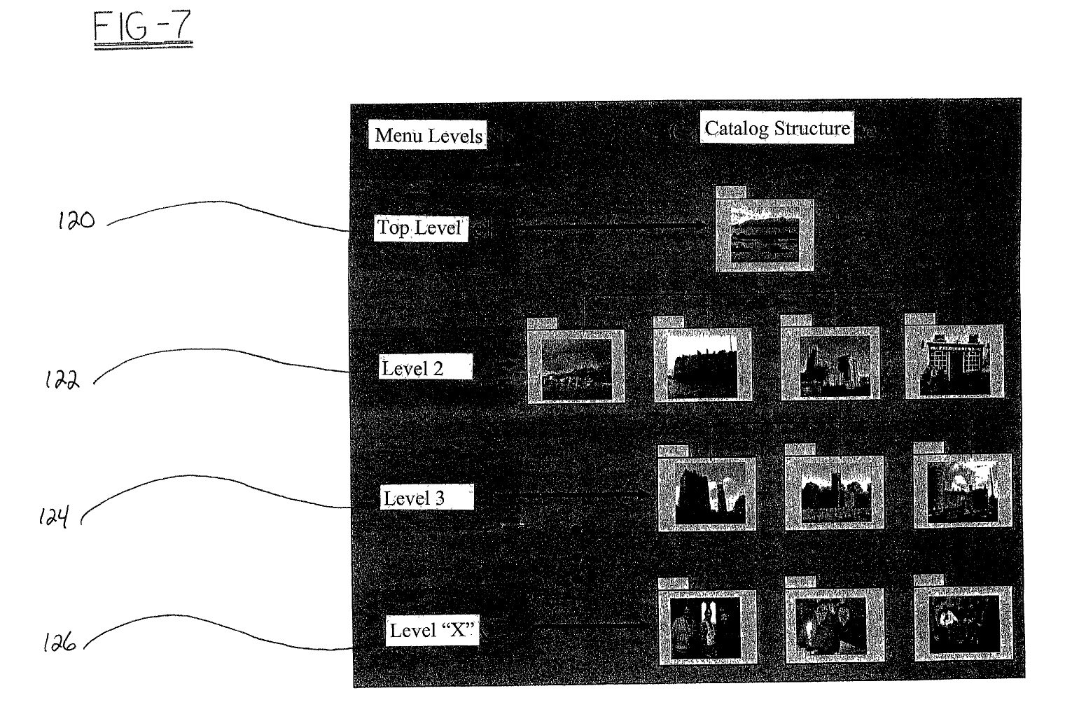

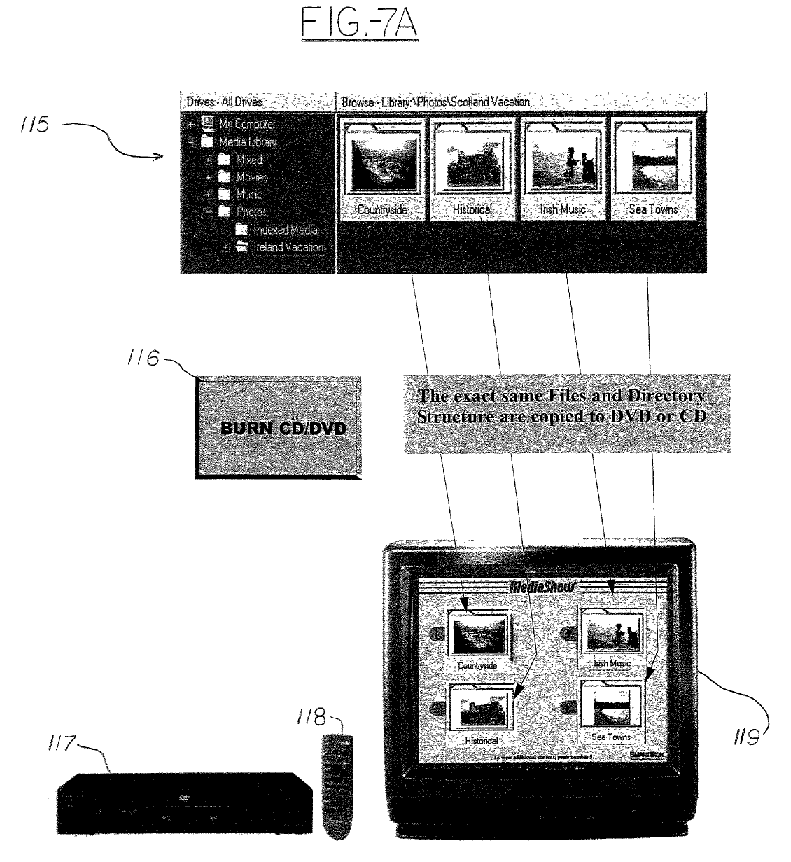

In this manner, such as shown in FIG. 7, the user can simply organize the multimedia content, such as for a subject (e.g. Ireland Vacation), that which can then be transferred to removable media and shared with others. The management system may support the ability to create a slide show as an example, which then may be saved as an album. In this way the user could then create a slide show of this slide show saved as an album by means of the authoring utility.

Once the user selects the multimedia catalog at 94, a one-button command may be provided on the user interface, to create a multimedia presentation on removable media such as CD/DVD media from the organized multimedia catalog at 96. Alternatively, the interface could support dragging the album to the CD/R component of the multimedia management system interface. The multimedia management system will then automatically convert any multimedia data to be compatible with the target media (e.g. a VCD 2.0 CD) by encoding the data at 98. The authoring utility then takes the file structure presented in the multimedia system album and creates a CD/DVD disk image, which maintains the hierarchical relationship between the albums and sub-albums in the multimedia management system.

For example, the catalog structure of organization provided by the multimedia management system could comprise a hierarchical arrangement of the multimedia as shown in FIG. 7. The interface 120 may provide a listing of media content in the library or database associated with the multimedia management system at 121, allowing the user to select desired content. The interface 120 may also provide a graphical representation of the selected content at 122. In the example shown, the user has selected the multimedia content in the system relating to an Ireland vacation, with the structure of albums relating to this content shown. The hierarchical structure created by the user by means of the multimedia management system is shown to include a Top Album 123, being the Ireland Vacation in this example, and Albums 124, relating to content related to “Countryside”, “Historical”, “Irish Music’ and “Sea Towns” as examples. Even further, the content has been organized into sub-albums 125 within the “Historical” Album, comprising “Castles” and “Churches” as examples. Upon selection of the “Historical” Album, the interface 120 will display the content within the Sub-Albums in the display area 122 for browsing. To provide automatic authoring and burning of a multimedia presentation on removable media, the hierarchical relationship of the content is used. Upon selection of the one button author and burn function 126 via the interface 120, an author/burn wizard will be launched to initially author the content into a multimedia presentation. In the example shown in FIG. 7, the author/burn wizard comprises an algorithm to navigate through the content and create a presentation, such as in the following example. Each Album in the selected hierarchy of content is analyzed and assigned the Attribute of a “Play List” or a “Folder”. A Play List is an Album that contains multimedia files, but does not contain any Folders. A Folder is an Album that has a Sub-Album. If an Album contains both multimedia files and a Sub-Album. In such a case, the algorithm may be configured to assign the original Album the Attribute of Folder, and to create a new virtual Album of the remaining content, which is assigned the Attribute of a Play List. Once the list of Albums is assigned Attributes in this manner, the list of Albums is organized to create Menu buttons and associated multimedia content to create a multimedia presentation on removable media. The following Table shows the Ireland Vacation example in terms of assigning Attributes and mapping the content as organized in the multimedia management system to removable media. With reference to FIG. 7, the hierarchy shown is treated as follows:

TABLE 1

| 1. | Top Album = Ireland Vacation, Assigned Attribute = Folder | |
|---|---|---|
| | 1. | Level 2 Album = Countryside, Assigned Attribute = Playlist |
| | | Picture 1 |
| | | Picture 2 |
| | | Picture 3 |
| | | Picture 4 |
| | | Picture 5 |
| | 2. | Level 2 Album = Seaside, Assigned Attribute = Playlist |
| | | Picture 6 |
| | | Picture 7 |
| | | Picture 8 |
| | | Picture 9 |
| | | Video 1 |
| | 3. | Level 2 Album = Historical, Assigned Attribute = Folder |

| 1. | Level 3 Album = Churches, Assigned Attribute = Playlist |
|---|---|
| | Picture 10 |
| | Picture 11 |
| | Picture 12 |
| | Picture 13 |
| | Video 2 |
| 2. | Level 3 Album = Castles, Assigned Attribute = Playlist |

Picture 14
Picture 15
Picture 16
Picture 17
Video 3

| | |
|---|---|
| 4. | Level 2 Album = Irish Songs, Assigned Attribute = Playlist |

Song 1
Song 2
Song 3

Based upon the Assignments made to the Albums and/or Sub-Albums, such as in the previous example, the system then maps the content to removable media, such as to create a DVD slideshow, as follows:

TABLE 2

| 1. | Title of DVD Slide Show: Top Album = Ireland Vacation, | |
|---|---|---|
| | Attribute = Folder | |
| | 1. | Button 1 on First menu in DVD Slide Show: Countryside, |
| | | Attribute = Playlist |
| | | These slides would play when button 1 is pressed: |
| | | Picture 1 |
| | | Picture 2 |
| | | Picture 3 |
| | | Picture 4 |
| | | Picture 5 |
| | 2. | Button 2 on First menu in DVD Slide Show: Seaside, |
| | | Attribute = Playlist |
| | | These slides would play when button 2 is pressed: |
| | | Picture 6 |
| | | Picture 7 |
| | | Picture 8 |
| | | Picture 9 |
| | | Video 1 |
| | 3. | Button 3 on First menu in DVD Slide Show: Historical, |
| | | Attribute = Folder |
| | | A new menu with 2 buttons would appear when button 3 is |
| | | pressed. |

| | |
|---|---|
| 1. | Button 1 on Menu under Button 3 of First menu in DVD |
| | Slide Show Churches, Attribute = Playlist |
| | These slides would play when button 1 is pressed: |
| | Picture 10 |
| | Picture 11 |
| | Picture 12 |
| | Picture 13 |
| | Video 2 |
| 2. | Button 2 on Menu under Button 3 of First menu in DVD |
| | Slide Show Castles, Attribute = Playlist |
| | These slides would play when button 2 is pressed: |
| | Picture 14 |
| | Picture 15 |
| | Picture 16 |
| | Picture 17 |
| | Video 3 |

| | |
|---|---|
| 4. | Button 4 on First menu in DVD Slide Show Irish Songs, |
| | Attribute = Playlist |
| | These slides would play when button 2 is pressed: |
| | Song 1 |
| | Song 2 |
| | Song 3 |

It should thus be seen that based upon the hierarchy of the content as organized in the multimedia management system, a multimedia presentation is easily created and burned or output onto removable media as desired. Although the example shown included a variety of Albums, some including Sub-Albums, it should be recognized that regardless of the structure of the multimedia content as organized by the user, the one button authoring and burning function allows a presentation to be created and produced on removable media with a single operation command, which could simply provide the removable media with the multimedia content which begins to play upon pressing the Play button of the DVD player or the like, a single menu item which begins the presentation when selected by the user on playback, or a multi-level menu structure created, such as described in the above example, to allow selective navigation through the content by means of the menu operated by the DVD remote control or the like.

The ability to automatically use the hierarchical structure in creating the menu structure on the CD/DVD then simplifies the playback of the CD/DVD by others. The system then automatically provides the disk image to the CD/DVD burning software at 102, and bums the encoded data to the CD/DVD in the specified format, such as VCD 2.0, SVCD or DVD formats. As seen in FIG. 7A, the procedure to create a multimedia presentation on removable media related to the example given above is shown graphically, and comprises organization of the multimedia content in the user interface at 115. A Burn CD/DVD button 116 provided on the user interface is implemented once the content has been organized in the desired fashion. The utility creates the CD/DVD or other media with the same file and directory structure being mapped to the removable media so that upon playback via a CD/DVD player 117, the content is displayed in a menu directory for navigation by use of the remote control 118 for the player 117. As seen on the TV or monitor 119 coupled to the player 117, the file and directory structure as organized in the multimedia management system is copied to the menu displayed thereon. In the example shown, the menu associated with the multimedia presentation created using the one button authoring/burning system of the invention comprises the main menu buttons relating to “Countryside”, “Historical”, “Irish Music” and “Sea Towns”, which the user would select using the DVD remote control 118. It should be recognized in the example given, if the user selected the “Historical” menu button, the additional menu items relating to the Sub-Albums” of “Castles” and “Churches” would be displayed on the monitor 119 for selection.

An alternative embodiment of the authoring utility is shown in FIG. 6A. The user may perform a similar function manually by selecting the authoring utility at 104, and selecting and organizing the multimedia content at 106. The multimedia material is encoded in a predetermined format at 108, corresponding to the removable media on which it is to be recorded. The user may then be prompted to create the menu/directory hierarchy, which will be viewed when the media is accessed by selection of the catalog structure for the multimedia content at 110. This system allows the user to customize the way in which the newly transferred multimedia content is later accessed. To further customize the multimedia content and/or access to the content, the authoring utility allows the user to select options for presentation and storage of multimedia content in association with menus/directories based upon the selected multimedia content at 112, and in accordance with the user selected catalog structure of the content.

The options for presentation and storage of the multimedia content at 112 may include a variety of features, the following of which are only certain examples. After the multimedia content is selected and organized at 106, encoded at 108 and catalogued at 110, the user may add a music track to the multimedia data to go along with the multimedia content when downloaded to removable media, including multi track or surround sound capabilities which would allow a great amount of flexibility in the types of audio information added to the multimedia content, such as voice and music. Thus, in addition to or apart from music, voice data may be added, allowing narration to be added to go along with a slideshow downloaded to the CD as an example. The media management system may allow narration to be added by a user when previewing the media presentation or slide show on the PC by means of a microphone connected to the PC. The media management system could be configured to provide user selectable functions when previewing a slide show, such as record and stop buttons to facilitate adding narration in association with current slides being viewed. The management system also allows audio files to be stored with other multimedia content, wherein the present invention would allow audio or other information to be automatically assigned across all media files in a folder when authoring a CD/DVD. Thus, various enhancements can be added to certain multimedia content, such as digital pictures, digital video or the like. In addition, the user may also be prompted to select the format type for the multimedia content, such as VCD 2.0, SVCD or DVD formats, to allow the created CD to be played on any DVD player or dedicated player which supports these formats. As an alternative, the created removable media may be designed for use in other computers, and along with the multimedia content, software may be provided for playback of the content on another computer. For example, a viewer supporting the media management system may be downloaded to the removable media, such that upon insertion into a computer, the application will be automatically launched to allow viewing of the multimedia content on the computer. Alternatively, the system could provide a way to play back on a PC the DVD, SVCD and VCD2.0 disks created by the media management system. This could be in addition to be able to play back the removable media in the DVD player. Thereafter, the user is prompted to create the CD/DVD media or other removable media at 114. Specifically, the user inserts some type of removable, recordable media 114 such as a CD-R, DVD-R, or MD into the Personal Computer's removable media drive. The multimedia content is recorded on the removable media in the desired user selected catalog structure for subsequent playback and viewing thereof, simplifying both the creation of the content as well as subsequent use. The options as described or other such options may be provided for enhancing or manipulation of the multimedia content as desired in either of the embodiments of the authoring utility.

The attributes of the multimedia management system desirably format multimedia content into a hierarchical structure that simplifies identifying and navigating through the content. The same attributes are desirably transferred to the organization and structure of the content on the removable media. As described, the authoring utility may allow the user with a one-button command to author a multimedia presentation and output it to removable media such as to create a CD/DVD which can be played on any suitable DVD player supporting formats such as VCD 2.0, SVCD and DVD. The multimedia management system will support Play List navigation functionality defined in the VCD 2.0, SVCD and DVD system specifications. The “blind” navigation functionality specified by the VCD 2.0 and SVCD specification allows the user to interact with the DVD player using its remote control. As examples of the types of commands which can be structured into the organization of the multimedia content to provide menu navigation capabilities in the playback of the multimedia content on a DVD player, the following are representative. A Next Linkage command will provide functionality to go the next entry in the Play List and begin playing. As an example, the Next Linkage function may be assigned to the >>| button on the DVD/Video CD remote. A Previous Linkage function may be programmed to allow the user to go the previous entry in the Play List and begin playing. The Previous Linkage function may be assigned to the |<< button on the DVD/video CD remote. A Return Linkage command would allow the user to go a specified entry in the Play List as set forth on a menu displayed on the video monitor. The Return Linkage function may be assigned to the “RETURN” button on the DVD/Video CD remote. Another example would be a Numeric Linkage command, which would allow the user to go to numerical entry in the Play List, which has been programmed to correspond with the number pressed. The Numeric Linkage may respond to the numeric keys on the DVD/Video CD remote. The numeric keys of the remote may thus be assigned to the menu items recorded on the CD.

In a form of the invention as briefly described previously, the multimedia management system allows the user to organize multimedia content into a hierarchical scheme. The authoring utility then allows the hierarchical scheme to be used to translate or transfer the multimedia content to removable media using a single user implemented operation. Thus, using the multimedia management system, the content can be arranged using the “blind” navigation functionality specified by the VCD 2.0 and SVCD specifications. This allows the user to select the one-button author and burn feature as described. As an alternative, some of the functions that are automated by organizing the multimedia content in a particular manner, could form the basis for prompts to the user, which would allow menu structures to be created. The simplicity of a “one button author and burn” feature is desirable, and the multimedia management system can perform analysis of the menu structure for the album selected for downloading onto a removable medium, and create the appropriate menu images. Menu images may be text if desired, but also could be a selected archived picture into a thumbnail (small picture) picture that can be used in the menu/directory hierarchy. The use of a small picture of a selected item visually aids the user of the removable media in navigating the menu structure and in selecting the desired content to be viewed. Additionally, the media-authoring tool allows file names of the archived multimedia data to be incorporated into the file structure and used as menu/directory identifiers if desired. As an example, under a hierarchical organization scheme, a top-level album becomes the name of the menu, which automatically is generated upon playing in a DVD player. Each of the sub-albums becomes an option on the main menu. Further, any subcategories within sub-albums become menus under the appropriate sub-album from the main menu. The multimedia management system calls the authoring program, and the content for generating menu items is encoded, such content being pictures, music or video, and mapped into the appropriate format, such as Mpeg format. SVCD uses Mpeg 2 and VCD 2.0 uses Mpeg 1 as examples. The authoring utility then receives the following data for each thumbnail or other multimedia content contained in the selected album and any sub-albums or sub-categories, as an example. The type of file, such as Menu, Still, Video or Audio, the duration to display the Still, Video or Audio and the location of the actual contents of the file. Further, the location of the Next Item in the Play List, the location of the Previous Item in Play List, or the location of the Item in the Play List for the RETURN function is received. If the type of file is a Menu entry, then the list of which entries are assigned to a numerical number on the remote control are received. Once the authoring utility receives the data for each of the Menu items, it creates an image of the CD with the appropriate Play List information and the Mpeg stream. The “one-button burn” utility then takes the CD image created by the authoring utility and burns the contents to a CD as described. The mapping of menu files to the burned contents on the CD greatly facilitates navigation of the multimedia content, and allows use of a DVD remote control unit in this regard.

The mapping of multimedia data to the removable storage media to include the hierarchical structure of the data as created with the media management system is more particularly provided by an API interface for creating title project script files which describe the content, layout, structure and navigation of the multimedia content to be compiled by the compiler of the authoring utility. The user may therefore translate a desired multimedia experience into script files, which direct the title compiler of the authoring utility to create a title for recording to CD, DVD media or other media. For descriptive purposes, the file structure may be thought of as including Slides, which define a presentation to be made, and a Tray, being a container having zero or more Slides. The multimedia presentation will thus include infrastructure navigation, being a default order in which Slides are arranged in the tray. The infrastructure navigation can deviate from the default by programming options selected by the user in the authoring utility. A specific Slide Type is provided to address viewer navigational options or provides interactive navigation, enabling the creation of titles, which have menus a title viewer would use to interactively navigate through the title. In the preferred structure of the multimedia data, a Tray will provide a “named” object within the title, and by default, every title will include a “main” Tray. Additional Trays can be defined and given names by the user. A Slide then defines a presentation by use of Slide attributes selected by the user. A presentation may be comprised of three basic attributes, video content, audio content and control parameters as examples. The types of content and control attributes determine the type of Slide and ultimately the type of presentation made. Each Slide will comprise at least one attribute, but not all attributes are “required” entry attributes, but are instead optional. Optional attributes modify the way Slides are compiled and presented. As previously mentioned, Slide attributes such as Next Key Linkage, Return Key Linkage and Previous Key Linkage identify infrastructure links which may be selected by the viewer by means of a remote control associated with the media player. In addition, other attributes, such as Time Code information, and Area of Interest, Slide Name and Duration may also be provided to facilitate playback operations. The Time Code is used to specify a point in time in the string format of the encoded multimedia data. The Area of Interest identifies an area of interest within a stream, such as within an audio file or within a Mpeg video stream. An Area of Interest may be defined by two Time Codes, being the in and out times in the data stream. The Slide Name may be a character string representative of the unique name of the Slide, and Duration is a period of time added to a Slide presentation. For example, Duration may be defined to specify how long a Still Slide is presented before moving onto the next presentation. Depending upon the nature of the multimedia data, the presentation will be tailored to a users desired format, and may as an example include, Still Slides, Video Slides, AV Stream Slides, Menu Slides or Video Menu Slides. A Still Slide presents a photographic still image display, and as previously mentioned, may optionally include audio. The attributes for a Still Slide include Content files, such as a raster image file or audio file, the Slide Name, and the Duration and optionally menu operations such as the Next Key, Return Key, Previous Key or Area of Interest. For a Video Slide, a video stream is presented to the viewer, and may include audio. The attributes of a Video Slide may include Content files, such as a video file or audio file. The Slide Name, the Duration and optionally menu operations as with a Still Slide may be provided. For a Video Slide, if a Duration is applied, it may be applied at the end of a video stream, wherein the last video frame may be displayed in a freeze frame mode for the Duration time.

An AV Stream Slide is similar to a Still Slide, but includes audio and generally will comprise a combination of two or more photographic image files presented over a single unbroken audio presentation. Each image file may be synchronized to present at a different point in time relative to the beginning of the stream, and presentation rates may be selected, such as rates of 1 Hz or slower. When the presentation starts, audio begins to play and the first image file may be displayed, and as the audio stream continues to play, a next defined image file will be displayed at a specified Time Code. This function can occur without a break in the audio, and the display duration of each image may be defined by the display time of the next image in the stream or the end of the stream. The attributes associated with an AV Stream Slide may again include Content files, including raster image files and/or audio files, Slide Name, Duration and Image File Time Code assigned for each image file added to the Slide. A Loop Audio attribute may be provided to allow repetition of audio in the event there are image time codes located beyond the end of the audio stream. If a Loop Audio attribute is set, the audio file will be extended by concatenation to accommodate the additional image files. Menu attributes may again be set if desired.

A Menu Slide is a specialized version of a Still Slide, and the presentation method is similar thereto. The Menu Slide also has associated therewith at least one “interactive navigation” hot spot or button. Each such button is programmed to link to a specific location within the Title if selected by the viewer. A Menu has one or more buttons, with each button assigned a link to address using the target Slide Name, the name of the Slide to be presented in the event the viewer selects the button. The attributes of the Menu Slide may again include Content files similar to a Still Slide, Slide Name, button definitions, such as Button Key Code number relating to the remote control or key code sequence to select the button, the button coordinate location and a link to a Target Name of a Slide to be presented next if the button is selected. A Loop Counter may be provided when audio is included with the Menu presentation, to selectively loop audio content in a desired manner. The Duration attribute on a Menu Slide is used as a Menu timeout facility, and Menu operation attributes may again be provided if desired. A Video Menu Slide is similar to the Menu Slide but includes full motion video instead of photographic still image files, in suitable digital format. The Video Menu Slide presents the video stream to the viewer, and the viewer can select to navigate to another point in the file during video playback. There may also be associated with this type of Slide one or more “interactive navigation” hot spots or buttons to link to a specific location within the Title if selected by the viewer. The attributes of a Video Menu Slide may include Content files, Slide name, button definitions similar to the Menu Slide, a Loop Counter, and if desired Duration and Menu operation attributes.

For the types of Slides described above, proper file formats for the type of playback device are provided. Such formats may be referred to as “target ready” formats, or Content files, which are format compliant with the target play format. Depending upon the playback device to be used, the user selects a target ready format for the multimedia data which is previously described, may include Video CD formats, including VCD 2.0, SVCD or DVD video format as examples.

Implementation of the interface described above may use three objects, being the Project object, the Tray object and the Slide object to define a presentation. The objects are arranged to form a distributed hierarchical or tree structure. The root of the Title Project tree is the Project object or script generator interface. This object is created by the application when required and is used to create a Title Project file compatible with the title compiler interface. A Tray object will contain zero or more Slide objects, while a Slide object defines a content presentation as defined above. As there are a number of different types of Slide configurations available as described above, all derived from the same common class object, each Slide is provided with a set of required and/or optional attributes, for example Content files as described. The interface then provides various functions for creating a new Slide object, and adding a Slide to a Project as examples. After creation of a new Slide object, the application may use other functions to fill in the required and optional attributes, and the new Slide may be added to the Title Project. Adding a Slide to the Project will typically be the final step in the Slide creation process.

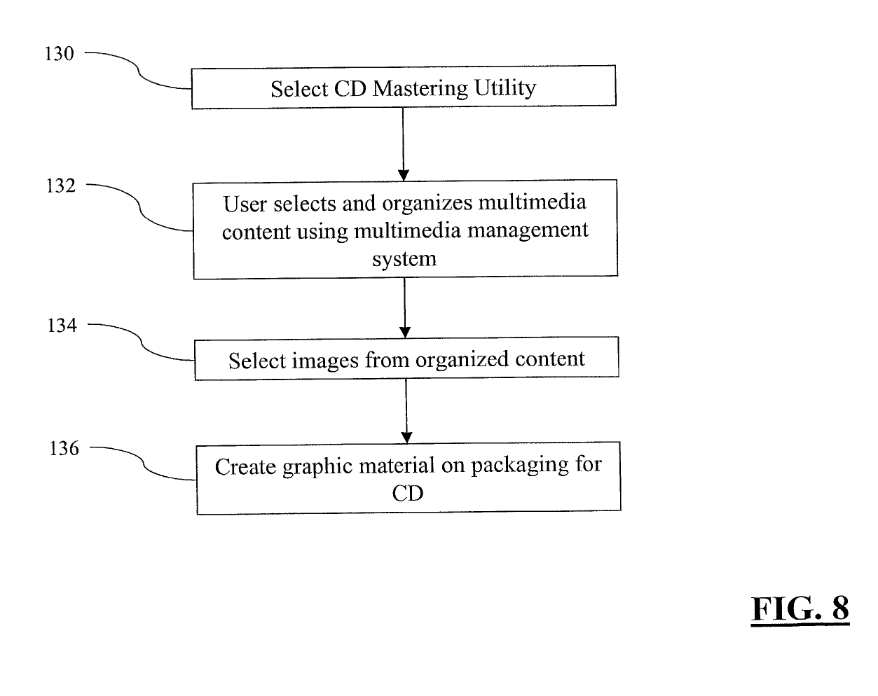

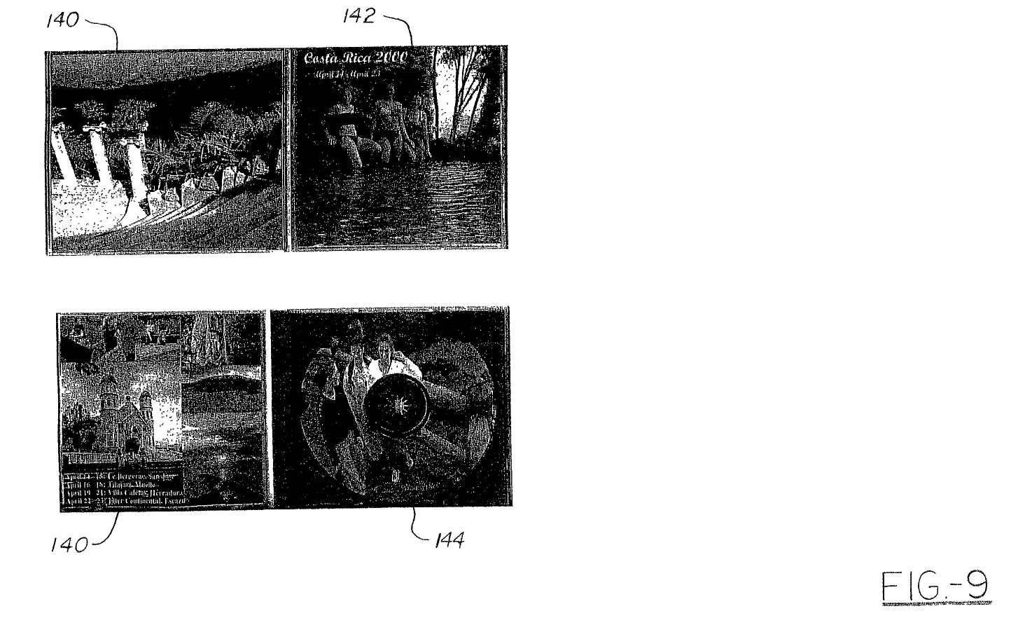

Another aspect of the present invention is illustrated by FIG. 8, which describes a CD mastering utility system 130 for assisting the user in creating a complete, fully mastered removable media product. The CD mastering utility 64 as referred to in FIG. 4, is selected at 130 which in conjunction with the multimedia management system, allows the user to select and organize multimedia content at 132. This step is similar to that as described with reference to FIG. 6, and preferably allows this organization into a hierarchical scheme comprise at least one top-level, and may further comprise at least one sub-level. The CD mastering utility 130 thereafter prompts the user to select images from the organized multimedia content at 134 for full CD mastering, which for creating a removable multimedia such as a CD, may include a CD label, cover, insert, jewel case and contents. Thus, once the user has selected a catalog or catalogs which are to be mastered to a CD, the creation utility 130 prompts the user to select images from the catalogs at 134 for the CD graphics, and allows them to drop text into the CD graphics. As shown in FIG. 9, the mastering utility program 130 allows the user to create customized graphics/text for the label 144, cover 140, and insert 142 for a CD/DVD and its protective jewel case. As an alternative, the hierarchical catalog structure of the multimedia content may allow these materials to be generated automatically, in a one-button operation, such as by using a top-level image for the CD label and cover, and a sub-level image for other of the CD graphics or text information. In this manner, no selections will have to be made by the user, as the selections are made based upon the logical organization of the multimedia content in the hierarchical structure. It should also be recognized that a software mastering program 130 for the creation of customized graphics for labels, covers, inserts is also contemplated for removable media such as a Minidisk, and other recordable, portable storage media.

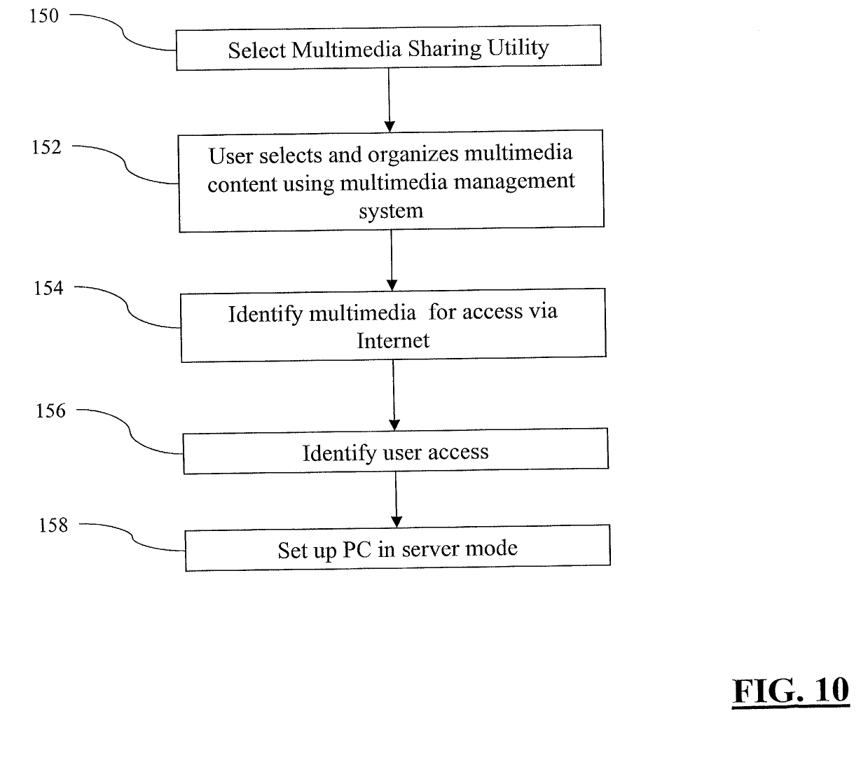

A further component of the present invention is the media sharing utility 150, which is illustrated in FIG. 10. This multimedia utility allows the user to organize multimedia content to be shared with other individuals via the Internet on their own PC. Previously, to share such content via the internet, a user would have to set up their own web site, post content which is to be shared, and refer others to that site. In the present invention, such content may be easily organized and shared on their own PC, with others then being able to connect to the PC via the Internet for viewing the material. With today's technology, private Internet sessions can be established, in which one computer is set up as a server, and another computer as a client, allowing communication between the computers linked via the Internet. As an example, there have been tools developed to allow sharing of music files via the Internet, such as Napster, representing the types of technologies to allow such sharing sessions to be established. Alternatively, the sharing utility 150 may be used to share multimedia content over the Internet, Intranet, or any type of computer network. Many times pictures, videos, and audio are captured and then simply stored on the PC to never be seen again, the Internet sharing software allows one to organize pictures on their PC with Internet sharing utility to post the multimedia content for selective access. By making the multimedia content available over a computer network such as the Internet, the user can share the content with a large number of people simultaneously. The PC can be set in a share mode to allow the sharing of content, and still be used for other tasks at the same time the content is being viewed via this utility. Further, when a user accesses the multimedia data in the sharing computer, the content can be automatically downloaded to the users PC to add the content to their multimedia management system if desired.

The multimedia sharing utility 150 is selected, and desired multimedia content selected and organized at 152. The user is prompted to identify the multimedia content for access via the Internet at 154, and to identify users who are granted access to the designated multimedia content at 156. Security measures, such as a user name and password may be implemented to only allow viewing of the content by designated individuals as specified by the user at 156. The computer may then be set up in a server mode at 158 to allow communication with a client computer, and access of the multimedia content thereby. If the client computer has a compatible multimedia management system resident thereon, the multimedia content as organized at 152, may be easily integrated into the client computer database. As a further example, the system and methods may also allow automatic adjustment of the resolution of the content for playback based upon the characteristics of the users particular playback system. In sharing content via the Internet, a user may have a slow connection, between the server and client, and it would then be preferable to download only the minimum amount of data to speed transfer times. The system can be configured to only download the data for content that can be supported by the clients display system. For example, if the clients system display can only support up to VGA screen resolution, then it would not be necessary to send an image with higher resolution than this. The system could compare the resolution of the content being transferred with the maximum resolution of the target computer. If the resolution of the content is higher than the maximum resolution of the target computer, the software could convert the content to a desired lower resolution prior to transfer.

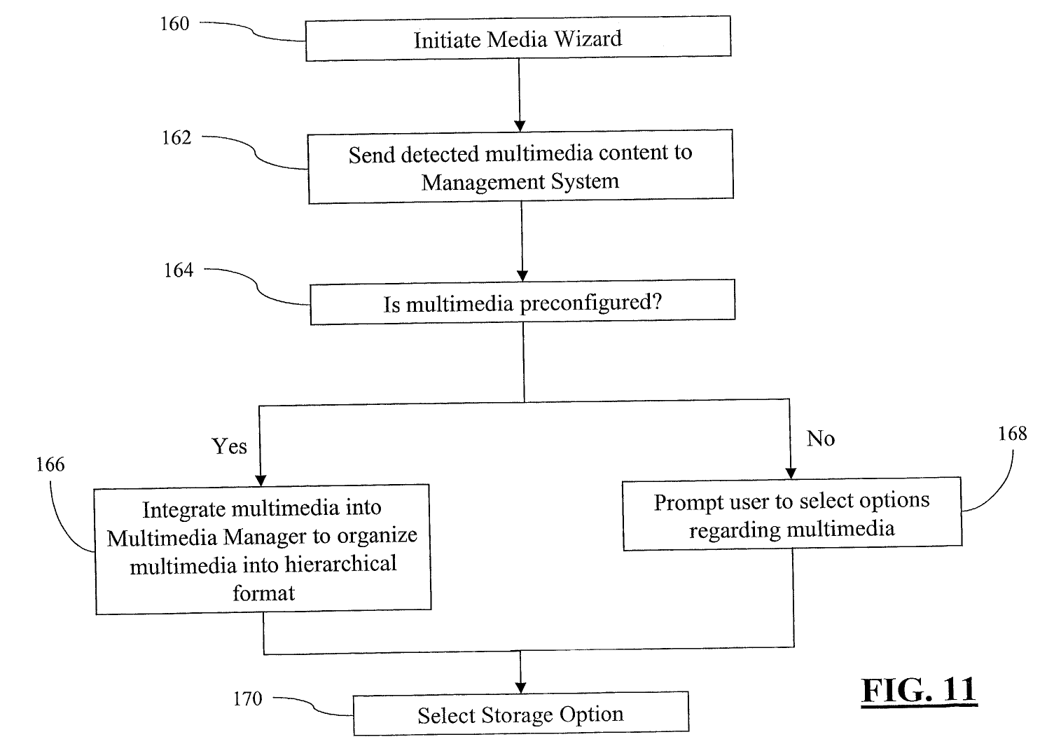

The media wizard utility 68 as referred to in FIG. 4 is further described in FIG. 11, allowing multimedia content to be easily integrated into a multimedia management system and/or stored on a removable media device. The media wizard is initiated at 160, which can occur in various manners. A removable media reader, such as a flash media reader, may be configured with firmware to support the multimedia management system, or the operating system can be used to notify the multimedia management system that new removable media has been inserted, regardless of the type of removable media. The firmware on the flash reader would automatically notify the management system when it detected flash memory being inserted. The management system would be automatically initiated on the computer, and would launch the media wizard at 160, and send detected multimedia content into the management system at 162. As an alternative, preconfigured multimedia content placed on removable media could automatically launch the media wizard 160 upon insertion into the computer. Preconfigured multimedia content would be configured in a manner to be compatible with the multimedia management system, with multimedia content already organized in a hierarchical arrangement on the removable media. For example, DataPlay, Inc. is planning to market a digital memory device, which allows a very large amount of digital data to be stored in a very small size device. Multimedia content providers can store multimedia content on the media so that when it is plugged into a reader or a PC, the content will be in a format the multimedia management system will recognize, such that it will automatically pull the content into a hierarchical scheme comprising at least one top-level, and may further comprise at least one sub- level. Thus, multimedia content providers, could provide digital audio files or digital movies stored on such memory devices, the memory device then simply being interconnected to a PC and automatically integrated into the multimedia management system resident thereon. Information contained within the memory device would allow creation of multimedia content in the hierarchical structure within a predetermined category depending upon the content itself, such as a new audio album, a movie or the like. For example, audio data may be stored in association with the multimedia management system in any suitable format, and the authoring utility previously described could be used to automatically create removable media with the content. MP3 data disks, Digital Audio CD's or the like may then be easily created in a form for playback on suitable player devices. The multimedia content provider could introduce copy protection into the material to avoid subsequent sharing of this content. Thus, the media wizard 160 will determine if the multimedia content is preconfigured content at 164, and if so, will automatically integrate the multimedia content into the multimedia system to organize it into a hierarchical format at 166. Alternatively, if the multimedia content is not preconfigured at 164, the system will prompt the user to select options regarding the multimedia content at 168. Alternatively, the system could analyze the multimedia data created by the user and automatically integrate the data into the proper catalogs in the database based upon the type of multimedia data file the content is. In this manner, a user could create digital photograph slideshows by simply taking digital pictures and storing such pictures on a smart media removable flash memory or other suitable removable memory device. When the flash memory is inserted into a flash reader, and the reader interconnected to a PC, the flash reader will notify the multimedia management system that new media is detected, and will launch the management system, either immediately or the next occasion where the multimedia management system is opened by the user. The management system will read in the multimedia content, such as reading in thumbnails of photographs from the flash memory, and prompt the user to select thumbnails that can be used for folder album covers in the hierarchical catalog structure. The management system may then prompt the user to identify which album or albums the user wants to store each picture in. Once in this format, either as preconfigured content at 166 or user content at 168, the user then may select a storage option at 170, such as a one-button CD burn option on the management system interface, which would transfer the created album to a CD as previously described. Alternatively, the user could create a removable media for playback in a PC, or may maintain the content within the management system database. At step 168, the media wizard 160 may allow the user to delete any unwanted picture by selecting the pictures thumbnail and pressing a delete option on the screen. Alternatively, the user could rotate any pictures by selecting specific thumbnails and pressing an option on the screen to rotate the picture. The wizard would then prompt the user for a name of an image to assign to a new album within the hierarchical catalog structure, and would display the thumbnail of the images to allow the user to select one of them for the cover of the newly created album. The user may then be given the option of inserting another smart media flash memory with images, and these steps can be repeated until all pictures are introduced into the management system. The user may then be presented with options to play a slideshow of the pictures on the PC screen, printout the pictures on a printer, create a video file, create a video presentation, create audio files, create removable media or any other desirable output option. More particularly, the multimedia management system may provide prompting for the user to output multimedia information in a variety of forms or manners, such as allowing printing of the media or creating a multimedia presentation on removable media such as a CD having multimedia data formatted in the SVCD, VCD 2.0, DVD or CDA formats as an example. Further, the user could output data for storage on a CD or other removable media, such as in the MP3, JPEG or other formats for later retrieval using the multimedia management system on a PC. The user may also create a video on a CD by outputting the information as an MPEG 1.0 or MPEG 2.0 stream to a CD or other removable media. The system also allows a user to output a DVD clip or movie file image, allowing burning of a DVD, if the user has suitable equipment.

If the user selects burning a CD slideshow, the wizard may prompt the user to select accompanying music, which could be played across their pictures during the CD slideshow. Various musical themes may be provided for selection by the user. The wizard 160 would then call the authoring utility as described previously, and specify the slideshow menu options for the CD. As an example, a first menu option may be provided to play a slideshow of all the pictures in the new album with the selected music also being played. A menu option 2 would display a sub-menu with options to play a slide show of grouped pictures within the hierarchical structure of the cataloged multimedia content. A third menu option may display a slideshow developed on the multimedia management system, authoring utilities as well as other aspects thereof, or other menu items could be included for content provided on the removable media. The menu options may again be selected using the numerical keypad on a remote control associated with the DVD player as an example.

The media wizard 160 may also be configured to be used when a multimedia management system is installed for a first time on a PC and when new multimedia content is copied to the hard drive. During a first time install, the wizard 160 will present in a tree view of the folders on the hard drive which contain multimedia content. The user will be able to easily navigate the tree to view the actual multimedia content of each folder. The user will then be presented with an option to select content to add to the management system database, and the wizard launched to put the appropriate information into the management system database, such as a pointer to the multimedia files or indexing a thumbnail image of the file, etc. If new multimedia files are copied to the hard drive, a monitor program resident as part of the management system will detect such new multimedia files. Upon detection, or the next time the management system is run, the wizard 160 will automatically run, and the new content may be added into new or existing folders or new or existing albums within the management system database. The monitor program may also keep track of deleted and/or moved files. For deleted files, the system may remove the pointer in the management system database. For moved files, the system will update the pointers in the database to point to the new location of the media file.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

1. A system for producing a multimedia presentation comprising:
a computer program for organizing multimedia data in a hierarchical structure in association with an electronic storage device; and
a computer program automatically creating menu information from the selected multimedia data based upon the hierarchical structure.

2. The system according to claim 1, wherein the hierarchical structure comprises at least one top level directory having at least one multimedia data file.

3. The system according to claim 1, wherein the hierarchical structure comprises at least one top level directory having at least one sub-directory having at least one multimedia data file.

4. The system according to claim 1, wherein the hierarchical structure comprises at least a top level directory and at least one sub-level directory having at least multimedia data file, with the top level data file used to generate a top level menu command in the multimedia presentation, and the at least one sub-level data file used to generate at least one sub-level menu command in the multimedia presentation.

5. The system according to claim 1, wherein the computer program for creating menu information allows output of the information in a manner selected from the group consisting of printing media, creating a multimedia presentation on removable media, storing data on removable media, creating a video file and creating a DVD movie file.

6. The system according to claim 1, wherein the computer program for creating menu information outputs the information to removable media in a selected format.

7. The system according to claim 6, wherein the selected format is a format selected from the group consisting of VCD 2.0, SVCD, DVD, Data CD and CDA CD formats.

8. A system for producing media containing customized multimedia content comprising:
a computer program for organizing multimedia data in association with an electronic storage device;
a computer program for encoding selected organized multimedia data into a predetermined format;
a computer program used to create menus for the selected multimedia data for inclusion in the selected multimedia data; and
a computer program for creating an image of the selected organized multimedia data and outputting the image.

9. The system according to claim 8, wherein,
the image is output to removable media which is compatible for playback in a suitable playback device.

10. The system according to claim 8, wherein,
the computer program for organizing and managing multimedia data structures the multimedia data in a hierarchical structure including a top level.

11. The system according to claim 10, wherein,
the computer program for organizing multimedia data structures the multimedia data in a hierarchical structure further comprising at least one sub-level.

12. The system according to claim 8, wherein,
the multimedia data is encoded into a digital format suitable for playback on a DVD player supporting SVCD or VCD 2.0 formats.

13. The system according to claim 8, wherein,
the menus comprises thumbnail pictures representative of the multimedia data.

14. The system according to claim 8, wherein,
the computer program for organizing the multimedia data into a hierarchical format, and the computer program for creating menu information utilizes the hierarchical structure of the organized multimedia data to create the menu information.

15. The system according to claim 8, wherein,
the computer program for creating an image automatically selects and creates an image from the organized multimedia data outputs the selected multimedia data to removable media upon execution of a single operation.

16. The system according to claim 8, wherein,
the computer program for creating an image of the selected multimedia data outputs the selected multimedia data to removable media upon execution of a single operation.

17. The system according to claim 8, wherein,
the menu information comprises commands selected from the group consisting of next linkage, previous linkage, return linkage, and numeric linkage.

18. The system according to claim 8, wherein,
the multimedia data is encoded into a digital format for playback on a digital format playback device, and menu information therein allows navigation through the selected multimedia data when playing back the data.

19. A system for mastering a removable storage media containing customized multimedia content comprising:
a computer program organizing multimedia data in a hierarchical structure in association with an electronic storage device;
a computer program for selecting predetermined multimedia data from the organized multimedia data;
a computer program for automatically selecting graphic information from the selected multimedia data based upon the hierarchical structure for use on packaging associated with the removable media; and
a computer program for outputting the selected graphic information for printing packaging associated with the removable media.

20. The system according to claim 19, wherein,
the computer program for organizing multimedia data structures the data into a hierarchical format, and graphic information is automatically selected from the hierarchical format for use on the packaging.

21. The system according to claim 19, wherein,
the program for selecting graphic information automatically selects such information from the selected multimedia data for printing on the packaging.

22. A system for enabling sharing of multimedia data over the Internet comprising:
a computer program for organizing multimedia data in association with an electronic storage device associated with a computer being connected to the Internet;
a computer program for selecting predetermined multimedia data from the multimedia data;
a computer program to set the computer in a shared mode such that the selected multimedia data may be accessed by a user via an Internet connection.

23. The system according to claim 22, wherein,
the program for selecting predetermined multimedia data allows the user to select multimedia data designed to be viewed by a selected authorized user.

24. The system according to claim 22, further comprising security measures for identifying users attempting to access the multimedia data to verify that such users are authorized users for access to the selected multimedia data.

25. The system according to claim 22, wherein upon accessing the multimedia data, the multimedia data is automatically downloaded to the users computer..

26. A system for integrating multimedia data into a multimedia management system comprising:
a computer program for monitoring a computer for multimedia data input thereto;
a computer program for copying detected multimedia data to a multimedia management system database;
a computer program for prompting a user to select options relating to the configuration of the multimedia data and for selecting the output form of the multimedia data.

27. The system according to claim 26, wherein,
the program for monitoring automatically detects any new multimedia data input, and launches the multimedia management system and copy the detected multimedia data to the management system database.

28. The system according to claim 26, wherein,
the program for monitoring automatically detects any new multimedia data input, and launches the multimedia management system the next time the multimedia management system is opened to copy the detected multimedia data to the management system database.

29. The system according to claim 26, wherein,
the program for prompting the user provides user selectable options selected from the group consisting of deleting any multimedia data, rotating pictures contained in the multimedia data, naming of multimedia data, inserting additional multimedia data, inserting audio information, displaying multimedia data and downloading selected multimedia to a removable storage media.

30. The system according to claim 26, wherein,
the multimedia data is preconfigured into a format compatible with the multimedia management system to be automatically inserted in the system database in a predetermined configuration.

31. The system according to claim 26, wherein,
the multimedia data is user generated, and the program for prompting a user to select options enables the multimedia data to be inserted into the multimedia management system database in a predetermined configuration based upon the type of mm data.

32. A data processing system for managing multimedia content comprising:
a central computing device and a display;
means for organizing multimedia data;
means for mapping multimedia data into a predetermined format; and
means for transferring mapped multimedia data to a removable storage medium.

33. A computer program product comprising:
a computer usable medium having computer readable program code means embodied in said medium for organizing multimedia content; and
the computer usable medium having computer readable program code means embodied in said medium for automatically mapping and transferring multimedia data to a removable storage medium.

34. A method of managing multimedia content, the method comprising the steps of:
(a) developing an organizational structure for said multimedia data;
(b) selecting an operation to create a multimedia presentation using a computer system wherein a plurality of multimedia data files are authored dependent upon the organizational structure;
(c) encoding the authored multimedia data files into a predetermined format; and
(d) transferring said multimedia data to a removable storage medium.

35. A system for producing removable media having customized multimedia content comprising:
a computer program for organizing multimedia data in association with an electronic storage device, the program creating a database having a plurality of directories having at least one multimedia data file, the plurality of directories being assigned an attribute selected from the group consisting of directory having at least one subdirectory and a directory having a list of at least one multimedia data file;
a computer program using the assignment of the attribute for mapping the multimedia data files to removable media in a selected format, whereby playback of the multimedia data files in association with the removable media is controlled by the selected format.

36. The system as in claim 35, wherein at least one directory includes both at least one subdirectory and a list of multimedia data files, with the at least one subdirectory assigned the attribute of a directory and the remaining multimedia data files assigned the attribute of a list of multimedia data files.
